(19) United States
(12) Patent Application Publication
(10) Pub. No.: US 2023/0398781 A1
(43) Pub. Date: Dec. 14, 2023

(54) PRINTING APPARATUS AND PRINTING METHOD

(71) Applicant: SCREEN HOLDINGS CO.,LTD., Kyoto (JP)

(72) Inventors: Kazuhiko Asada, Kyoto (JP); Shogo MUTO, Kyoto (JP)

(21) Appl. No.: 18/035,004

(22) PCT Filed: Oct. 21, 2021
(86) PCT No.: PCT/JP2021/038897

§ 371 Date: May 2, 2023

(30) Foreign Application Priority Data
Nov. 9, 2020 (JP) 2020-186300

(51) Int. Cl. B41J 2/165; B41J 29/17; B41J 2/045

(52) U.S. Cl. CPC B41J 2/165; B41J 29/17; B41J 2/04526; B41J 2/04586; B41J 2002/16582

(57) ABSTRACT

The present invention includes a head holder configured to collectively holding a plurality of discharge heads and a collective head mover configured to move the head holder between a printing space above the printing medium being conveyed in the conveying direction and a retraction space separated from the printing space. Therefore, is provided a printing technique capable of printing a high-quality image at low cost by discharging inks from a plurality of discharge heads arranged adjacent to each other in a direction parallel to a conveying direction of a printing medium while reciprocally moving the respective discharge heads between a printing space and a retraction space.

### TECHNICAL FIELD

This invention relates to a printing apparatus and a printing method for moving a plurality of discharge heads for discharging mutually different inks between a printing space and a retraction space.

The disclosure of Japanese Patent Application No. 2020-186300 filed on Nov. 9, 2020 including specification, drawings and claims is incorporated herein by reference in its entirety.

### BACKGROUND

A printing apparatus is known which prints an image on the upper surface of a printing medium by discharging a water-based or oil-based ink from a discharge head in an ink-jet method. For example, in a printing apparatus described in patent literature 1, a plurality of discharge heads are arrayed along a conveying direction of a printing medium. Each discharge head prints by discharging ink droplets to the upper surface of the printing medium from a nozzle surface. Thus, if deposits adhering to the nozzle surface are dried and fixed, the clogging of a nozzle occurs, leading to a reduction in printing performance. Accordingly, in patent literature 1 above, a maintenance unit is provided in a retraction space separated in a horizontal direction from a printing space for performing printing, i.e. a space above the printing medium being conveyed in the conveying direction. A cleaning process such as flushing and purging is performed using the maintenance unit. Further, to prevent the drying of the inks on the nozzle surfaces, a capping process is performed by the maintenance unit.

### PATENT LITERATURE

[Patent Literature 1] JP 2017-177362A

### SUMMARY

### Technical Problem

In the printing apparatus described in patent literature 1, four discharge heads for respectively discharging the inks of mutually different colors are arranged in parallel to the conveying direction. To reciprocally move these plurality of discharge heads between the printing space and the retraction space, two moving mechanisms are also arranged in parallel to the conveying direction. More specifically, the four discharge heads for respectively discharging black, cyan, magenta and yellow inks are arranged in this order in the conveying direction. Out of these, the discharge head for discharging the black ink is moved by the moving mechanism for black. Further, the moving mechanism for color is provided adjacent to this moving mechanism for black to move three discharge heads for respectively discharging the cyan, magenta and yellow inks. In consideration of the moving mechanisms arranged in parallel, the black discharge head and the cyan discharge head are provided apart in the conveying direction. As a result, the following problems may occur. The first problem is that a position where the black ink is supplied and a position where the other inks are supplied are separated in the conveying direction and this is one of main factors for reducing printing accuracy. The second problem is that a plurality of moving mechanisms need to be provided and a plurality of maintenance units need to be provided accordingly, thereby causing an increase in apparatus cost.

This invention was developed in view of the above problems and aims to provide a printing technique capable of printing a high-quality image at low cost by discharging inks from a plurality of discharge heads arranged adjacent to each other in a direction parallel to a conveying direction of a printing medium while reciprocally moving the respective discharge heads between a printing space and a retraction space.

### Solution to Problem

One aspect of the invention is a printing apparatus for printing an image by discharging a plurality of mutually different inks to a printing medium being conveyed in a conveying direction. The printing apparatus includes: a plurality of discharge heads arranged adjacent to each other in a direction parallel to the conveying direction, each of the plurality of discharge heads configured to discharge the ink downward from a discharge surface; a head holder configured to collectively holding the plurality of discharge heads; and a collective head mover configured to move the head holder between a printing space above the printing medium being conveyed in the conveying direction and a retraction space separated from the printing space.

Other aspect of the invention is a printing method for printing an image by discharging a plurality of mutually different inks to a printing medium being conveyed in a conveying direction. The printing method includes: collectively moving a plurality of discharge heads for respectively discharging the mutually different inks downward to a printing space above the printing medium being conveyed in the conveying direction with the plurality of discharge heads arranged adjacent to each other in a direction parallel to the conveying direction; performing printing by the plurality of discharge heads moved to the printing space; and collectively moving the plurality of discharge heads to a retraction space separated from the printing space.

In the invention thus configured, the plurality of discharge heads are used to print a desired image on the printing medium. These discharge heads are arranged adjacent to each other in the direction parallel to the conveying direction, and respectively discharge the inks from the discharge surfaces to the printing medium after being collectively moved to the printing space. In this way, the image is printed on the printing medium. Further, these discharge heads are collectively moved from the printing space to the retraction space, whereby an operator can easily access each discharge head.

### Advantageous Effects of Invention

As described above, the plurality of discharge heads necessary for image printing can be collectively reciprocally moved between the printing space and the retraction space while being arranged adjacent to each other in the direction parallel to the conveying direction of the printing medium. Since the plurality of discharge heads can be moved only by the collective head mover in this way, apparatus cost can be reduced. Moreover, intervals between the discharge heads can be made narrower and printing quality can be more improved than a conventional technique for moving heads by a plurality of movers.

All of a plurality of constituent elements of each aspect of the invention described above are not essential and some of the plurality of constituent elements can be appropriately changed, deleted, replaced by other new constituent elements or have limited contents partially deleted in order to solve some or all of the aforementioned problems or to achieve some or all of effects described in this specification. Further, some or all of technical features included in one aspect of the invention described above can be combined with some or all of technical features included in another aspect of the invention described above to obtain one independent form of the invention in order to solve some or all of the aforementioned problems or to achieve some or all of the effects described in this specification.

### BRIEF DESCRIPTION OF DRAWINGS

FIG. 1 is a front view schematically showing an example of a printing system according to the invention.

FIG. 2A is a chart schematically showing the color printer, the color maintenance unit and configurations related to those.

FIG. 2B is a side view of the color printer and the color maintenance unit when viewed from a side downstream of the printing medium in the conveying direction.

FIG. 3 is a chart showing the positions of the color printer 32 and the color maintenance unit during printing standby, during printing and during maintenance by an operator.

FIG. 4 is a flow chart showing the vertical movement menu performed in the second embodiment of the printing apparatus according to the invention.

FIG. 5 is a diagram schematically showing an example of an operation in accordance with the vertical movement menu shown in FIG. 4.

FIG. 6 is a diagram schematically showing an example of an operation in accordance with a vertical movement menu in a third embodiment of the printing apparatus according to the invention.

### DESCRIPTION OF EMBODIMENTS

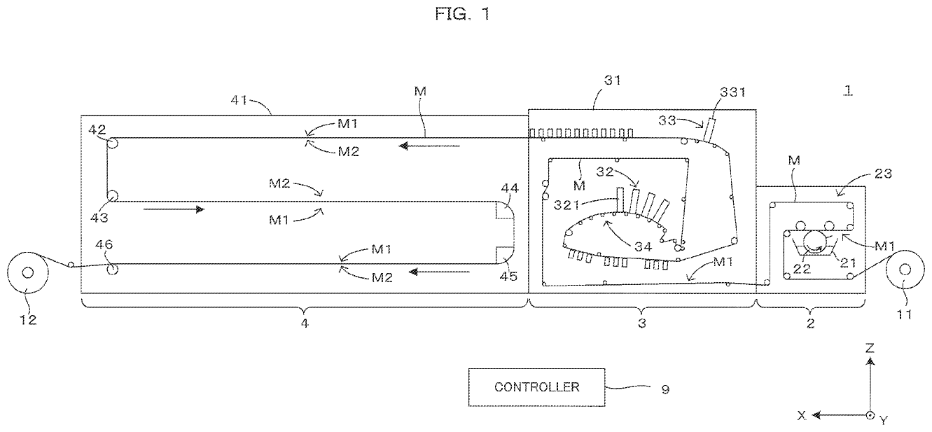

FIG. 1 is a front view schematically showing an example of a printing system equipped with a printing apparatus according to the invention. In FIG. 1 and subsequent figures, a horizontal direction in which a coating apparatus 2, a printing apparatus 3 and a drying apparatus 4 constituting a printing system 1 are arranged is referred to as an “X direction”, a horizontal direction from a right side toward a left side of FIG. 1 is referred to as a “+X direction” and an opposite direction is referred to as a “−X direction” to clarify an arrangement relationship of each component of the apparatus. Further, out of horizontal directions Y orthogonal to the X direction, a direction forward of the apparatuses is referred to as a “+Y direction” and a direction backward of the apparatuses is referred to as a “−Y direction”. Further, upward and downward directions along a vertical direction Z are respectively referred to as a “+Z direction” and a “−Z direction”.

This printing system 1 applies a coating process, a printing process and a drying process to a printing medium M while conveying the printing medium M in the form of a long strip from a feeding roll 11 to a winding roll 12 in a roll-to-roll manner by controlling each component of the apparatuses by a controller 9. That is, the coating apparatus 2 applies a coating liquid to the printing medium M. Then, the printing apparatus 3 prints an image by causing various inks to adhere to the printing medium M in an ink-jet method. Further, the drying apparatus 4 dries the inks adhering to the printing medium M. Note that a material of the printing medium M is a film made of OPP (oriented polypropylene), PET (polyethylene terephthalate) or the like. However, the material of the printing medium M is not limited to the film and may be paper or the like. Such a printing medium M is flexible. Further, out of both surfaces of the printing medium M, the surface on which images are to be printed is referred to as a front surface M1 and the surface opposite to the front surface M1 is referred to as a back surface M2 as appropriate.

The coating apparatus 2 includes a pan 21 storing a liquid primer (coating liquid), a gravure roller 22 partially immersed in the primer stored in the pan 21 and a conveyor 23 conveying the printing medium M. In the coating apparatus 2, a coating region is provided where the gravure roller 22 contacts the printing medium M conveyed by the conveyor 23 from below, and the conveyor 23 conveys the printing medium M along the coating region with the front surface M1 of the printing medium M facing down. On the other hand, the gravure roller 22 supplies the primer to the coating region by rotating while holding the primer on the peripheral surface thereof. In this way, the primer supplied by the gravure roller 22 is applied to the front surface M1 of the printing medium M in the coating region. Further, in the coating region, a moving direction of the printing medium M and a rotating direction of the peripheral surface of the gravure roller 22 are opposite. That is, the primer is applied to the printing medium M by a reverse kiss method. Then, the conveyor 23 carries out the printing medium M from the coating apparatus 2 to the printing apparatus 3 with the front surface M1 of the printing medium M having the primer applied thereto facing up.

The printing apparatus 3 includes a housing 31, a color printer 32 arranged in the housing 31, a white printer 33 arranged above the color printer 32 in the housing 31, and a conveyor 34 conveying the printing medium M by a plurality of rollers arranged in the housing 31.

The color printer 32 includes a plurality of (four) discharge heads 321 arrayed in the moving direction (direction from the other side X2 toward the one side X1) of the printing medium M above the printing medium M conveyed by the conveyor 31. The plurality of discharge heads 321 include nozzles facing the front surface M1 of the printing medium M passing therebelow from above, and discharge color inks of mutually different colors from the nozzles by the ink-jet method. Here, the color inks mean inks other than a white ink and include inks of cyan, magenta, yellow, black and the like. In this way, the plurality of discharge heads 321 of the color printer 32 print a color image on the front surface M1 of the printing medium M by discharging the color inks to the front surface M1 of the printing medium M passing therebelow from above.

Further, the white printer 33 includes a single discharge head 331 arranged above the printing medium M conveyed by the conveyor 34. The discharge head 331 includes nozzles facing the front surface M1 of the printing medium M passing therebelow from above, and discharges the white ink from the nozzles by the ink-jet method. In this way, the discharge head 321 of the white printer 33 prints a white image on the front surface M1 of the printing medium M by discharging the white ink to the front surface M1 of the printing medium M passing therebelow from above.

Note that, although not shown in FIG. 1, two types of dryers are provided in the housing 31 of the printing apparatus 3. One dryer is a pre-dryer for drying the color inks adhered to the surface M1 of the printing medium M by the color printer 32. The other dryer is an upper dryer for drying the white ink adhered to the surface M1 of the printing medium M by the white printer 33.

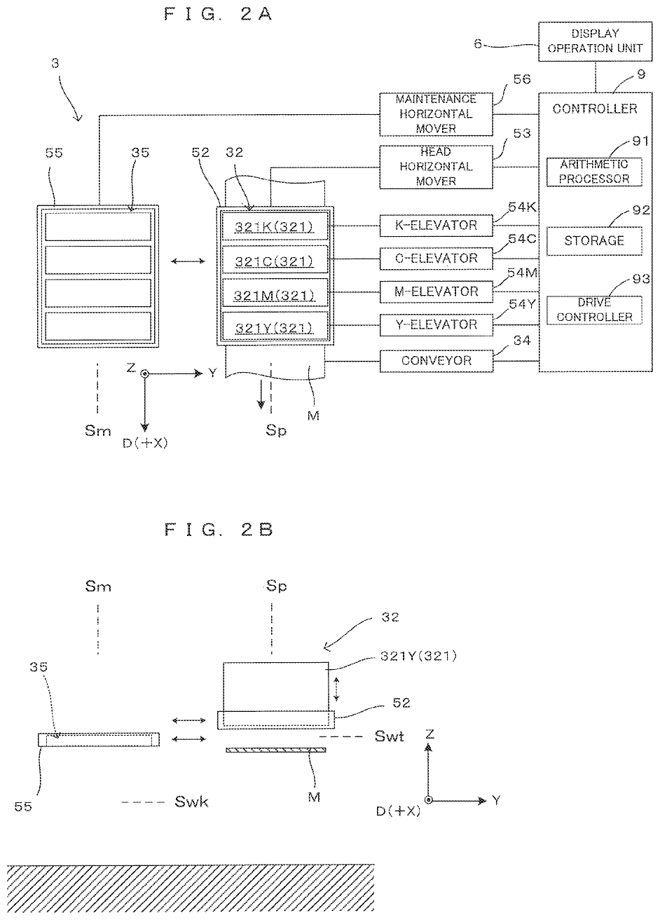

Further, the color printer 32 and the white printer 33 discharge the inks from nozzle surfaces in the ink-jet method. Thus, if a printing process is performed for a long time, discharge failures of the nozzles gradually occur. Further, when printing is temporarily stopped, the inks adhering to the nozzle surfaces may be solidified to cause a discharge failure. Accordingly, a color maintenance part (35 in FIG. 2 to be described later) corresponding to the color printer 32 is provided. The color maintenance part is separated from the discharge heads 321 in the horizontal direction Y during normal printing. When the discharge heads 321 require maintenance, the color maintenance part moves to a position right below the discharge heads 321 to perform various types of maintenance. Then, the color maintenance part is separated from the discharge heads 321 in the horizontal direction Y after the end of the maintenance. These points similarly apply also to the white printer 33. That is, a white maintenance part (36 in FIG. 2 to be described later) corresponding to the white printer 33 is provided away from the discharge head 331 in the horizontal direction Y. During maintenance, the white maintenance part moves to a position right below the discharge head 331 to perform various types of maintenance and is, thereafter, separated from the discharge head 331 in the horizontal direction Y.

Further, as described in patent literature 1, an operator may operate the nozzle surfaces of the discharge heads 321, 331 by directly accessing these. Thus, in the printing apparatus 3, the color printer 32 and the white printer 33 are movable in the horizontal direction Y. When an access of the operator becomes necessary, the color printer 32 and the white printer 33 are moved to retracted positions separated from printing positions in the horizontal direction Y.

As just described, in the printing apparatus 3, a horizontally moving mechanism is provided to move the color printer 32 and the color maintenance part in the Y direction. Further, a horizontally moving mechanism is provided to move the white printer 33 and the white maintenance part in the Y direction. Out of these horizontal moving mechanisms, the horizontal moving mechanism for moving the color printer 32 corresponds to an example of a “collective head mover” of the invention. Further, the horizontal moving mechanism for moving the color maintenance unit corresponds to an example of a “maintenance mover” of the invention. Further, the color printer 32 for printing a color image and a white printer 33 for printing a white image are provided in the printing apparatus 3, a color image corresponds to an example of an “image” of the invention and the printing apparatus 3 including the color printer 32 corresponds to an example of a “printing apparatus” of the invention. Note that the color printer 32, the color maintenance unit and the mechanism for moving those are described in detail later.

The drying apparatus 4 dries the inks adhering to the surface M1 of the printing medium M being conveyed from the printing apparatus 3. The drying apparatus 4 includes a housing 41 (drying furnace). Further, in the housing 41, rollers 42, 43 and 46 are arranged on a (+X) side and air turn bars 44, 45 are arranged on a (−X) side. By this arrangement, a substantially S-shaped conveyance path when viewed from a (+Y) side is configured, and the printing medium M is conveyed along this conveyance path. The inks adhering to the surface M1 of the printing medium M are dried during this conveyance. Then, the printing medium M subjected to the drying process is carried out from the drying apparatus 4 and wound on the winding roll 12.

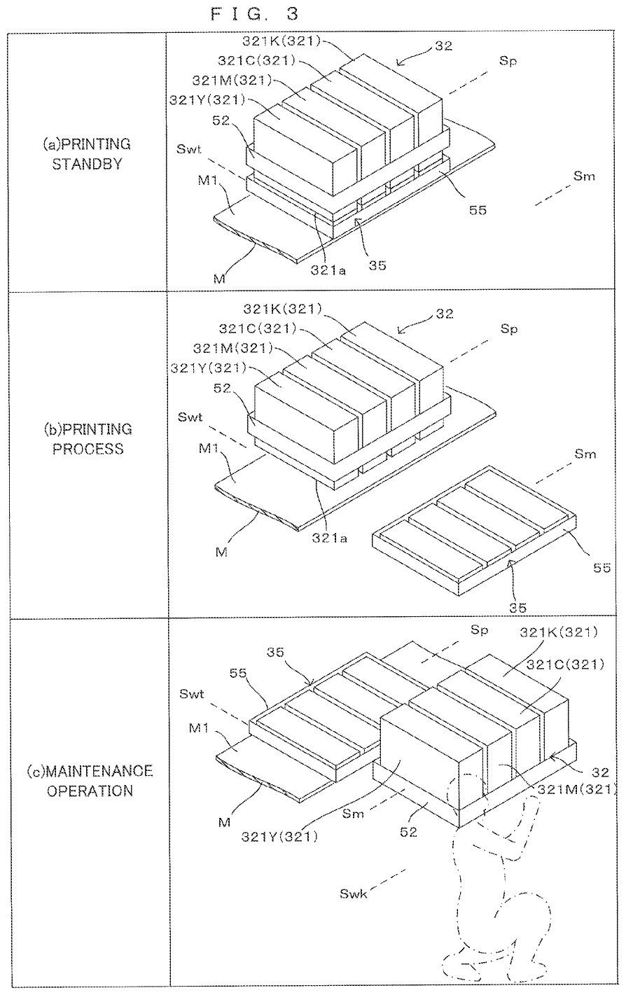

Next, the color printer 32, the color maintenance unit and the moving mechanism are described with reference to FIGS. 2A, 2B and 3. FIG. 2A is a chart schematically showing the color printer, the color maintenance unit and configurations related to those. Further, FIG. 2B is a side view of the color printer and the color maintenance unit when viewed from a side downstream of the printing medium in the conveying direction. Further, FIG. 3 is a chart showing the positions of the color printer 32 and the color maintenance unit during printing standby, during printing and during maintenance by an operator. Note that, in these figures, sign D denotes the conveying direction of the printing medium M. Particularly, in FIGS. 2A and 2B, the conveying direction D of the printing medium M substantially coincides with the (+X) direction. Further, as described later, an elevating direction of the discharge heads 321, i.e. a vertical direction, also substantially coincides with the Z direction.

In the color printer 32, the printing medium M is conveyed in the conveying direction D by the conveyor 34 operating in response to a conveyance command from the controller 9 as shown in FIG. 2A. Further, four discharge heads 321 necessary to print a color image are adjacently arranged in a direction parallel to the conveying direction D. As shown in FIG. 2B, each of the four discharge heads 321 has a lower surface capable of facing the front surface M1 of the printing medium M, and a discharge surface 321a for discharging the ink is provided on this lower surface. Note that, since a detailed configuration of the discharge head 321 is described, for example, in patent literature 1, the configuration of the discharge head 321 is not described here.

As shown in FIG. 2A, the black discharge head 321, the cyan discharge head 321, the magenta discharge head 321 and the yellow discharge head 321 are adjacently arranged in this order in the conveying direction D with the discharge surfaces 321a facing down. A color image is formed by discharging the inks of mutually different colors from these discharge heads 321 to the front surface M1 of the printing medium M. Hereinafter, in distinguishing and describing these discharge heads 321, the black discharge head, the cyan discharge head, the magenta discharge head and the yellow discharge head are respectively called the “black discharge head 321K”, the “cyan discharge head 321C”, the “magenta discharge head 321M” and the “yellow discharge head 321Y”. On the other hand, these are merely called the “discharge heads 321” when being described without being distinguished.

In the color printer 32, a head mounting frame 52 is provided to surround the four discharge heads 321 arranged adjacent to each other as shown in FIG. 2A. The four discharge heads 321 are mounted in the head mounting frame 52. As just described, in this embodiment, the head mounting frame 52 collectively holds the four discharge heads 321 movably in the vertical direction and functions as a “head holder” of the invention.

Further, a head horizontal mover 53 is connected to the head mounting frame 52. Thus, the head mounting frame 52 mounting the four discharge heads 321 is reciprocally moved between a printing space Sp above the printing medium M and a maintenance space Sm separated from the printing space Sp in the (−Y) direction by the head horizontal mover 53 operating in response to a horizontal movement command from the controller 9. Note that, in this embodiment, all the discharge heads 321 are positioned at original points (upper limits of elevation ranges) to be described later to avoid the interference of the discharge heads 321 and a maintenance mounting frame 55 when the head mounting frame 52 is reciprocally moved.

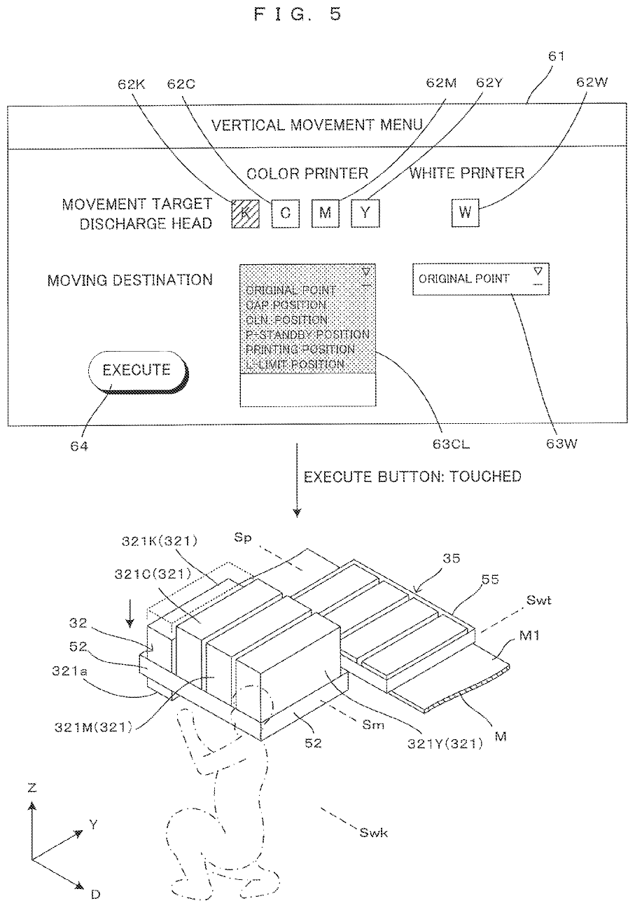

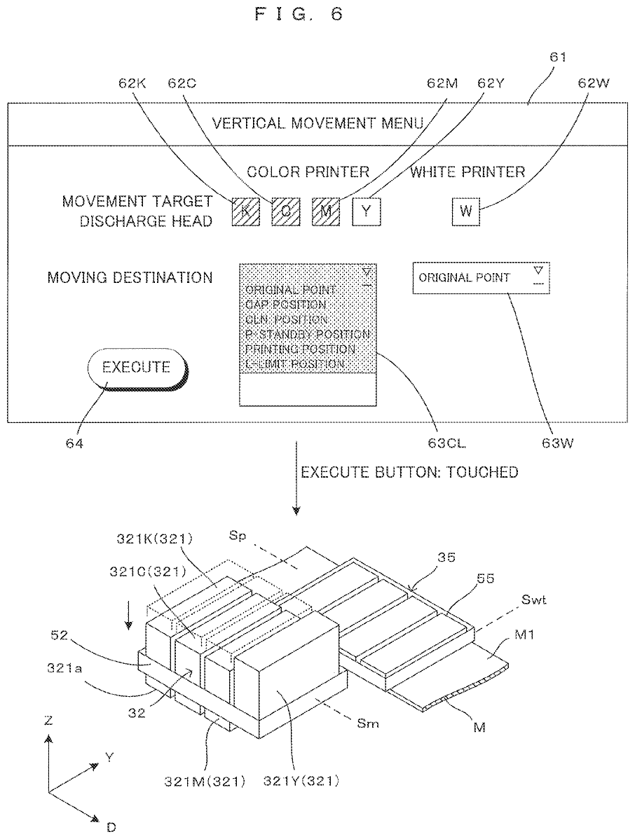

Further, although not shown in FIG. 2B, a head elevating mechanism is provided between a Y-direction end part of the yellow discharge head 321Y and the head mounting frame 52. This head elevating mechanism is connected to a yellow elevator 54Y. Thus, the yellow discharge head 321Y moves up or down in a certain elevation range and positioned in the vertical direction while being held in the head mounting frame 52 by the elevator 54Y operating in response to an elevation command from the controller 9. In this embodiment, the yellow discharge head 321Y can be positioned in six stages in the vertical direction, i.e. at the original point, which is an upper limit of the elevation range, a CAP position suitable for a capping process, a cleaning position suitable for a cleaning process, a printing standby position suitable for printing standby, a printing position at the time of printing and a maintenance position (lower limit position in FIGS. 5 and 6 to be described later) suitable for the maintenance of the discharge surface 321a by the operator. Note that, similarly to the yellow discharge head 321Y, the discharge heads 321M, 321C and 321K for the other ink colors are also respectively positioned in the vertical direction by a cyan elevator 54C, a magenta elevator 54M and a black elevator 54K. In this way, the discharge head 321K, 321C, 321M, 321Y of each color can be independently positioned by being moved up or down.

As shown in FIG. 2B, the maintenance mounting frame 55 is provided reciprocally movably between the printing space Sp and the maintenance space Sm on a side below the head mounting frame 52. The color maintenance unit 35 is mounted in the maintenance mounting frame 55. The color maintenance unit 35 is provided to be able to face the discharge surfaces 321a of the discharge heads 321 and has a function of performing the capping process and the cleaning process for the discharge heads 321. As just described, in this embodiment, the maintenance mounting frame 55 holds the color maintenance unit 35 and functions as a “maintenance holder” of the invention. Note that since a detailed configuration of the color maintenance unit 35 is described, for example, in patent literature 1, the configuration of the color maintenance unit 35 is not described here.

A maintenance horizontal mover 56 is connected to the maintenance mounting frame 55. Thus, the maintenance mounting frame 55 mounting the color maintenance unit 35 is reciprocally moved between a standby space Swt and the maintenance space Sm by the maintenance horizontal mover 56 operating in response to a horizontal movement command from the controller 9. This standby space Swt means a space sandwiched between the printing space Sp and the printing medium M as shown in FIG. 2B.

As shown in FIG. 2A, an arithmetic processor 91 constituted by a computer including a CPU (=Central Processing Unit), a RAM (=Random Access Memory) and the like, a storage 92 such as a hard disk drive and a drive controller 93 are provided in the controller 9 for controlling movements of the maintenance mounting frame 55 and the head mounting frame 52. The arithmetic processor 91 appropriately reads out a printing program and a maintenance program stored in the storage 92 in advance, develops the read-out programs in the RAM (not shown) and performs a printing process and a maintenance process. Further, a display operation unit 6 is connected to the controller 9. This display operation unit 6 has a function of displaying various pieces of information on the printing process and the maintenance process by the arithmetic processor 91, receiving various pieces of information input by the operator and giving the received information to the arithmetic processor 91. Although the display operation unit 6 corresponds to an example of an “input unit” of the invention in this embodiment as just described, it goes without saying that a display device for display various pieces of information and an input device for receiving only various pieces of information from an operator may be used instead of the display operation unit 6.

The drive controller 93 controls the head horizontal mover 53, the elevators 54K, 54C, 54M and 54Y and the maintenance horizontal mover 56 in accordance with the printing process and the maintenance process by the arithmetic processor 91. In this way, as described in detail next with reference to FIG. 3, the color printer 32 and the color maintenance unit 35 are moved to proper positions in the printing standby before the printing process, the printing process and a maintenance operation. Note that the white printer 33 and the white maintenance unit (not shown) are also configured similarly to the color ones except that only a white elevator (not shown) is provided to correspond to one discharge head 331, and the white printer 33 and the white maintenance unit are moved to proper positions by the drive controller 93.

In the printing standby, as shown in field (a) of FIG. 3, the head horizontal mover 53 moves the head mounting frame 52 to the printing space Sp in response to a movement command from the drive controller 93. Further, the maintenance horizontal mover 56 moves the maintenance mounting frame 55 to the standby space Swt. In this way, the four discharge heads 321 are collectively moved and positioned above the printing medium M. Further, the color maintenance unit 35 is moved to and positioned between the printing medium M and the discharge heads 321. In this way, the color maintenance unit 35 faces the discharge surfaces 321a of the four discharge heads 321. Further, when the capping process is performed during the printing standby, some or all of the elevators 54K, 54C, 54M and 54Y respectively independently position the discharge heads 321 as objects of the capping process to the CAP positions. Also when the cleaning process is performed, the discharge heads 321 as objects of the cleaning process are positioned to the cleaning positions by individual upward or downward movements of the discharge heads 321 by the elevators 54K, 54C, 54M and 54Y.

When the cleaning process by the arithmetic processor 91 is performed, the color maintenance unit 35 is moved from the standby space Swt to the maintenance space Sm by the maintenance horizontal mover 56 as shown in field (b) of FIG. 3. Thereafter, the discharge heads 321 are lowered to the printing positions by the elevators 54K, 54C, 54M and 54Y. In this way, intervals between the discharge surfaces 321a of the discharge heads 321 and the front surface M1 of the printing medium M are adjusted to a value suitable for ink-jet printing. After this interval adjustment is completed, the inks of the mutually different colors are discharged from the discharge surfaces 321a of the respective discharge heads 321 to the front surface M1 of the printing medium M being conveyed in the conveying direction D while the above intervals are maintained. As a result, a color image is formed on the printing medium M (printing process).

In the printing apparatus 3, the operator may need to perform maintenance (hereinafter, referred to as “operator maintenance”) by directly accessing the discharge surfaces 321a when a cumulative time of the printing process exceeds a certain time or due to a factor such as the occurrence of a trouble during the printing process or printing standby. In this case, the arithmetic processor 91 moves the color printer 32 to the maintenance space Sm by automatically detecting an operator maintenance command or receiving an operator maintenance command by the operator via the display operation unit 6. That is, as shown in field (c) of FIG. 3, the head horizontal mover 53 moves the head mounting frame 52 to the maintenance space Sm. At this time, if the color maintenance unit 35 is located in the maintenance space Sm, the color maintenance unit 35 is moved to the standby space Swt by the maintenance horizontal mover 56. This causes only the color printer 32 to be located in the maintenance space Sm. In this way, each discharge surface 321a is largely exposed to a working space Swk located below the maintenance space Sm. Therefore, the operator (shown by one-dot chain line in FIG. 3) can directly and easily access the discharge heads 321 from below.

As described above, according to this embodiment, the color printer 32 is configured such that the discharge heads 321K, 321C, 321M and 321Y used to print a color image on the printing medium M are collectively moved between the printing space Sp and the maintenance space Sm. Therefore, mechanisms for horizontally moving the discharge heads 321K, 321C, 321M and 321Y can be unified and simpler than a conventional apparatus.

Further, the discharge heads 321K, 321C, 321M and 321Y are adjacently arranged in the conveying direction D by collective movements of the discharge heads 321K, 321C, 321M and 321Y. Thus, intervals between the discharge heads 321 adjacent to each other can be narrowed and a color image can be printed with high quality. That is, if intervals between discharge heads are expanded as in the conventional apparatus, the position of the ink landed on the front surface M1 of the printing medium M from each discharge head may be shifted from a designed position in the conveying direction or a width direction of the printing medium M due to a state of conveyance (flapping, oblique feed, etc.) of the printing medium M being conveyed in the color printer 32. In contrast, the intervals between the discharge heads 321K, 321C, 321M and 321Y are narrow and printing positions are concentrated in the conveying direction D, whereby the ink of each color is hardly affected by the state of conveyance and can be landed at the designed position. As a result, the quality of the color image can be enhanced.

In the above first embodiment, when the operator performs maintenance, the four discharge heads 321K, 321C, 321M and 321Y are only collectively moved to the maintenance space Sm by the head horizontal mover 53. Thus, for example, as shown in field (c) of FIG. 3, the discharge heads 321K, 321C, 321M and 321Y are positioned at the same height position and the four discharge heads 321K, 321C, 321M and 321Y are arranged side by side. Here, if a case is considered where the discharge surface 321a of a specific one of the discharge heads 321 is directly accessed from below, this discharge head 321 is preferably caused to project downward as a maintenance target discharge head. This is because the discharge surface 321a of the maintenance target discharge head 321 is located lower than the discharge surfaces 321a of the other discharge heads and operability can be enhanced. Accordingly, in a second embodiment, a vertical movement menu for enhancing maintainability by an operator by switching the positions in the vertical direction of discharge heads 321K, 321C, 321M and 321Y located in a maintenance space Sm is additionally incorporated into a controller 9.

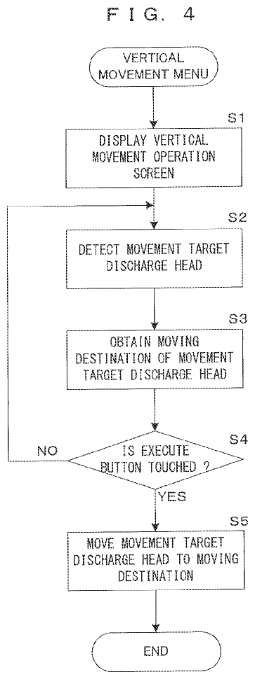

FIG. 4 is a flow chart showing the vertical movement menu performed in the second embodiment of the printing apparatus according to the invention. FIG. 5 is a diagram schematically showing an example of an operation in accordance with the vertical movement menu shown in FIG. 4. Note that an apparatus configuration of the second embodiment is basically the same as that of the first embodiment, and the second embodiment differs from the first embodiment only in that the vertical movement menu to be described in detail below is incorporated into a maintenance program. This point is similar also in a third embodiment to be described later with reference to FIG. 6.

In the second embodiment, if operator maintenance becomes necessary, a vertical movement operation screen 61 is displayed on a display operation unit 6 (Step S1). The vertical movement operation screen 61 has, for example, a configuration shown in an upper level of FIG. 5. Icons 62Y, 62M, 62C, 62K and 62W for designating a movement target discharge head from discharge heads 321 constituting a color printer 32 and a discharge head 331 constituting a white printer 33 are displayed on the vertical movement operation screen 61. Radio buttons or the like may be displayed instead of the icons. Here, if a maintenance operation is performed, for example, for the black discharge head 321K, an operator touches the black icon 62K. Then, an arithmetic processor 91 detects the selection of the black discharge head 321K as the movement target discharge head (Step S2). Note that a state of selection of the icon 62K is shown by hatching in FIG. 5.

Further, two drop-down lists 63CL, 63W are displayed on the vertical movement operation screen 61. The drop-down list 63CL is for designating a moving destination of the selected movement target discharge head 321 in the color printer 32. In this drop-down list 63CL, an operator can select the moving destination of the movement target discharge head 321 in an elevation range from six moving destinations (original point, CAP position, cleaning position, printing standby position, printing position and lower limit position). The other drop-down list 63W also has a function similar to the drop-down list 63CL. If selection by these drop-down lists 63CL, 63W is made, the arithmetic processor 91 obtains the moving destination of the movement target discharge head 321 (Step S3).

In next Step S4, the arithmetic processor 91 determines whether or not an execute button 64 displayed on the vertical movement operation screen 61 has been touched. While the touch of the execute button 64 is not confirmed (“NO” in Step S4), the arithmetic processor 91 repeatedly obtains the movement target discharge head (Step S2) and obtains the moving destination (Step S3). On the other hand, if the execute button 64 is touched, the arithmetic processor 91 moves the movement target discharge head, e.g. the black discharge head 321K, to the moving destination selected in Step S3 by controlling the elevator 54Y for vertically moving the black discharge head 321K while the head mounting frame 52 is moved from the printing space Sp to the maintenance space Sm to perform the maintenance operation or after the head mounting frame 52 is moved to the maintenance space Sm. For example, if the lower limit position suitable for the operator maintenance is selected as the moving destination in Step S3, the elevator 54K lowers and moves the black discharge head 321K to the lower limit position. In this way, for example, as shown in a lower level of FIG. 5, the black discharge head 321K projects downward while the other discharge heads 321Y, 321M and 321C except the black discharge head 321K are located at the original points (upper limits of the elevation ranges). Thus, the discharge surface 321a of the black discharge head 321K can be easily directly accessed from below the maintenance space Sm, i.e. from the working space Swk, and the operator maintenance can be efficiently performed.

Note that although a case where the black discharge head 321K is selected as the movement target discharge head has been described in the above second embodiment, the same applies also when the other discharge head 321Y, 321M, 321C is selected as the movement target discharge head. Further, the number of selections of the movement target discharge heads is not limited to “1”. For example, at the time of the maintenance operation from above as described next, a suitable number of selections of the movement target discharge heads is “3”.

Although the maintenance operation is performed by accessing from below the maintenance space Sm in the above second embodiment, the above vertical movement menu can be effectively used, for example, as shown in FIG. 6, also when the maintenance operation is performed by directly accessing the four discharge heads 321 located in the maintenance space Sm from above (third embodiment).

FIG. 6 is a diagram schematically showing an example of an operation in accordance with a vertical movement menu in a third embodiment of the printing apparatus according to the invention. The third embodiment largely differs from the second embodiment in that only a maintenance target discharge head 321 is caused to project upward by moving discharge heads 321 other than the maintenance target discharge head 321 to positions below original points, e.g. lower limit positions, and the configuration and operation thereof are the same as in the second embodiment.

In this third embodiment, if operator maintenance becomes necessary, a vertical movement operation screen 61 is displayed on a display operation unit 6 (Step S1). The vertical movement operation screen 61 has a configuration, for example, shown in an upper level of FIG. 6. Here, for example, if the operator maintenance is performed, for example, for the yellow discharge head 321Y, an operator touches icons other than the yellow one, i.e. a black icon 62K, a magenta icon 62M and a cyan icon 62C. Then, an arithmetic processor 91 detects the selection of the black discharge head 321K, the magenta icon 62M and the cyan icon 62C as movement target discharge heads 321 (Step S2). Note that a state where the icons 62K, 62M and 62C are selected is shown by hatching in FIG. 6.

Further, if a lower limit position is selected as a moving destination as shown in the upper level of FIG. 6, the arithmetic processor 91 obtains moving destinations of the movement target discharge heads 321 (Step S3). Then, at a timing at which an execute button 64 is touched, the arithmetic processor 91 moves the movement target discharge heads 321, e.g. the discharge heads 321K, 321M and 321C other than the yellow discharge head 321Y to the moving destinations selected in Step S3 by controlling elevators 54K, 54M and 54C for elevating the movement target discharge heads 321 while a head mounting frame 52 is moving from a printing space Sp to a maintenance space Sm or after a movement of the head mounting frame 52 to the maintenance space Sm. For example, if the lower limit position is selected as the moving destination in Step S3, the elevators 54K, 54M and 54C respectively lower and move the black discharge head 321K, the magenta discharge head 321M and the cyan discharge head 321C to the lower limit positions. For example, as shown in a lower level of FIG. 6, the other discharge heads 321K, 321M and 321C are located at the lower limit positions while the yellow discharge head 321Y is located at the original point (upper limit of an elevation range). In this way, the yellow discharge head 321Y projects upward and an upper end part of the yellow discharge head 321Y is easily directly accessed from above the maintenance space Sm. As a result, the operator can efficiently perform the operator maintenance.

As described above, in the above embodiments, the head mounting frame 52 corresponds to an example of a “head holder” of the invention. Further, the elevators 54Y, 54M, 54C, 54K correspond to an example of an “individual head mover” of the invention. Further, the maintenance space Sm corresponds to an example of a “retraction space” of the invention. Further, the movement target discharge head 321 and the moving destination correspond to an example of “information on the designation of a discharge head” of the invention.

Note that the invention is not limited to the embodiments described above and various changes other than the aforementioned ones can be made without departing from the gist of the invention. For example, although the printing apparatus 3 includes the white printer 33 in the above embodiments, the invention can be applied to a printing apparatus including only the color printer 32. Further, the number of the discharge heads 321 constituting the color printer 32 is not limited to “4”. That is, the invention can be applied to a printing apparatus in which a plurality of discharge heads for discharging mutually different inks can be adjacently arranged and a desired image is formed by the inks discharged from these discharge heads.

Further, although one of the four discharge heads 321 is set as the maintenance target discharge head in the second and third embodiments, the number of the maintenance target discharge heads is not limited to “1” and is arbitrary.

Further, in the second embodiment, the moving destination of the movement target discharge head 321 is designated as the lower limit position and the discharge heads 321 other than the one to be moved are located at the original points, thereby making the height positions of the discharge heads 321 in the vertical direction different and causing the maintenance target discharge head to project downward. A combination of the “height positions” is not limited to the one of the “lower limit position” and the “original points” and another combination may be adopted. Further, although the moving destination of the movement target discharge head 321 is selected by means of the drop-down list 63CL, the moving destination may be fixed. If the movement target discharge head 321 is designated, the moving destination thereof may be automatically set to the “lower limit position”. Note that these points are similar also in the third embodiment.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

### INDUSTRIAL APPLICABILITY

The invention is generally applicable to a printing technique for moving a plurality of discharge heads for discharging mutually different inks between a printing space and a retraction space.

### REFERENCE SIGNS LIST

3 printing apparatus
6 display operation unit
32 color printer
33 white printer
34 conveyor
35 color maintenance unit
52 head mounting frame (head holder)
53 head horizontal mover (collective head mover)
54C, 54K, 54M, 54Y elevator (individual head mover)
55 maintenance mounting frame
56 maintenance horizontal mover
61 vertical movement operation screen
93 drive controller
321, 321C, 321K, 321M, 321Y discharge head
321a discharge surface (of discharge head)
D conveying direction
M printing medium
Sm maintenance space (retraction space)
Sp printing space
Swk working space
Swt standby space

1. A printing apparatus for printing an image by discharging a plurality of mutually different inks to a printing medium being conveyed in a conveying direction, comprising:
a plurality of discharge heads arranged adjacent to each other in a direction parallel to the conveying direction, each of the plurality of discharge heads configured to discharge the ink downward from a discharge surface;
a head holder configured to collectively holding the plurality of discharge heads; and
a collective head mover configured to move the head holder between a printing space above the printing medium being conveyed in the conveying direction and a retraction space separated from the printing space.

2. The printing apparatus according to claim 1, further comprising an individual head mover configured to move the plurality of discharge heads upward and downward independently of each other.

3. The printing apparatus according to claim 2, wherein:
the collective head mover is configured to locate the plurality of discharge heads in the retraction space by moving the head holder to the retraction space, and
the individual head mover is configured to selectively cause a maintenance target discharge head, out of the plurality of discharge heads, to project downward from the retraction space by selectively moving the plurality of discharge heads upward and downward.

4. The printing apparatus according to claim 2, wherein:
the collective head mover is configured to locate the plurality of discharge heads in the retraction space by moving the head holder to the retraction space, and
the individual head mover is configured to selectively cause a maintenance target discharge head, out of the plurality of discharge heads, to project upward from the retraction space by selectively moving the plurality of discharge heads located in the retraction space upward and downward.

5. The printing apparatus according to claim 3, further comprising an input unit configured to receive designation of the discharge head to be moved by the individual head mover.

6. The printing apparatus according to claim 5, further comprising a drive controller configured to control the individual head mover based on information on the designation of the discharge head received by the input unit.

7. The printing apparatus according to claim 1, further comprising:
a maintenance unit provided to be able to face the plurality of discharge surfaces;
a maintenance holder configured to hold the maintenance unit; and
a maintenance mover configured to move the maintenance holder between a standby space and the retraction space, the standby space sandwiched between the printing medium being conveyed in the conveying direction, wherein
the maintenance mover is configured to move the maintenance holder to the standby space, when the plurality of discharge heads are located in the retraction space, so as to form a work space for enabling access to the plurality of discharge surfaces from below the retraction space.

8. A printing method for printing an image by discharging a plurality of mutually different inks to a printing medium being conveyed in a conveying direction, comprising:
collectively moving a plurality of discharge heads for respectively discharging the mutually different inks downward to a printing space above the printing medium being conveyed in the conveying direction with the plurality of discharge heads arranged adjacent to each other in a direction parallel to the conveying direction;
performing printing by the plurality of discharge heads moved to the printing space; and
collectively moving the plurality of discharge heads to a retraction space separated from the printing space.

9. The printing apparatus according to claim 4, further comprising an input unit configured to receive designation of the discharge head to be moved by the individual head mover.
